(19) United States
(12) Patent Application Publication
(10) Pub. No.: US 2004/0146656 A1
(43) Pub. Date: Jul. 29, 2004

(54) Apparatus and method for lubricating raised or protruding surfaces

(76) Inventor: Isaac Algaze, Aventura, FL (US)

Correspondence Address: David W Barman, 1101 NE 176 Terrace, North Miami Beach, FL, 33162, US

(21) Appl. No.: 10/757,333

(22) Filed: Jan. 14, 2004

Related U.S. Application Data
(60) Provisional application No. 60/442,877, filed on Jan. 28, 2003.

(51) Int. Cl. B05D 1/28; B05C 11/00; B05C 11/105

(52) U.S. Cl. 427/429; 118/500; 118/268

(57) ABSTRACT

An apparatus and method for lubricating a raised or protruding surface is described.

### INDEX TO RELATED APPLICATION

This application claims the benefit of provisional application serial No. 60/442,877 filed on Jan. 28, 2003.

### BACKGROUND OF THE INVENTION

The marketplace is replete with lubricants and devices for lubricating. There are literally millions of articles with moving parts that create friction. Any article that moves and creates friction needs to be lubricated in order to increase the functional life of the article. Engineers and maintenance persons are constantly striving to maintain and lubricate all types of articles that involve friction. U.S. Pat. No. 4,325,982 describes a lubricant on a zipper. However, this patent relates to lubrication during manufacture, and does not discuss maintenance lubrication. U.S. Pat. No. 5,956,816 describes an elastomer coating for buttons. The industry has recognized a need for a clean, easy to use, lubrication product, but has not yet met the needs addressed in the current invention.

### SUMMARY OF THE INVENTION

The subject invention relates to an apparatus and method for lubricating a raised or protruding surface.

The subject invention is particularly suitable for lubricating raised or protruding surface that are normally difficult to lubricate. Such surfaces are normally uneven and present unique difficulties regarding application of lubricants.

It is an object of the present invention to provide an apparatus for lubricating an uneven surface.

It is a further object of the present invention to provide an apparatus for lubricating a raised or protruding portion of an uneven surface.

It is a further object of the present invention to provide an apparatus for lubricating the raised or protruding portion of a door or window track.

It is a further object of the present invention to provide an apparatus for lubricating a snap fasteners.

It is a further object of the present invention to provide an apparatus for lubricating a zipper.

It is a further object of the present invention to provide an apparatus for lubricating with a clean, non-elastomer lubricant.

### BRIEF DESCRIPTION OF THE DRAWINGS

FIG. 1 Shows the insert removed from the holder.

FIG. 2 Shows the insert and the orientation when placed in the holder

FIG. 3 Show a cross section of the holder of one embodiment of the invention and the placement of the insert within said holder.

FIG. 4 Shows the assembled holder with the insert placed within.

FIG. 5 Shows the lubrication of the insert

FIGS. 6-8 show preferred uses of the apparatus of the present invention

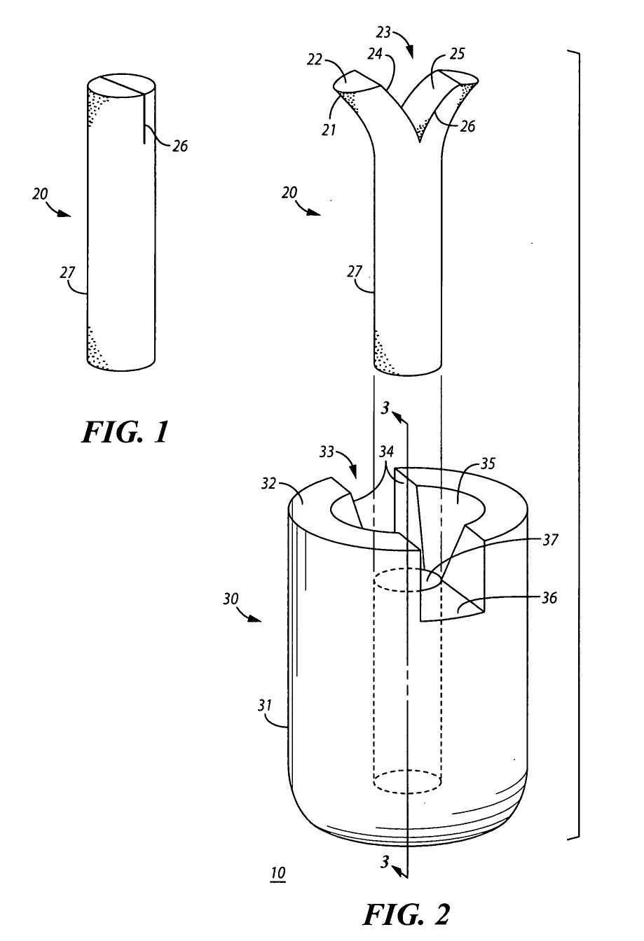

### DETAILED DESCRIPTION OF THE PREFERRED EMBODIMENTS

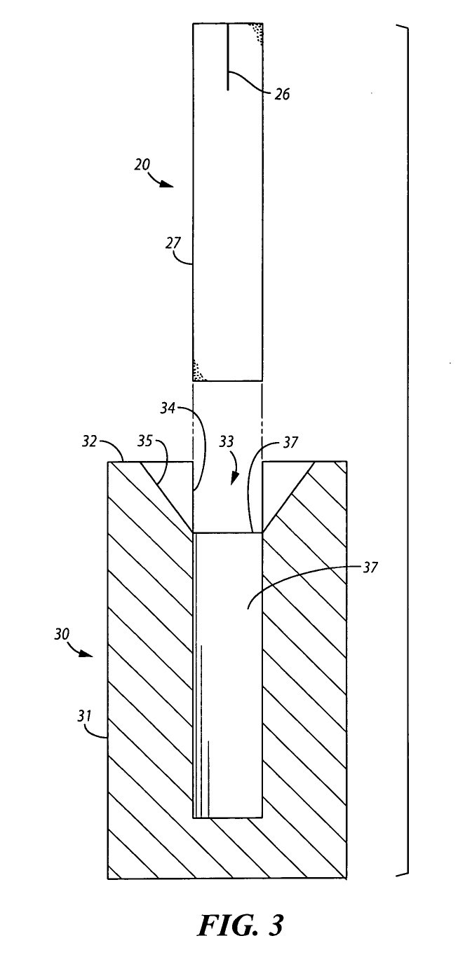

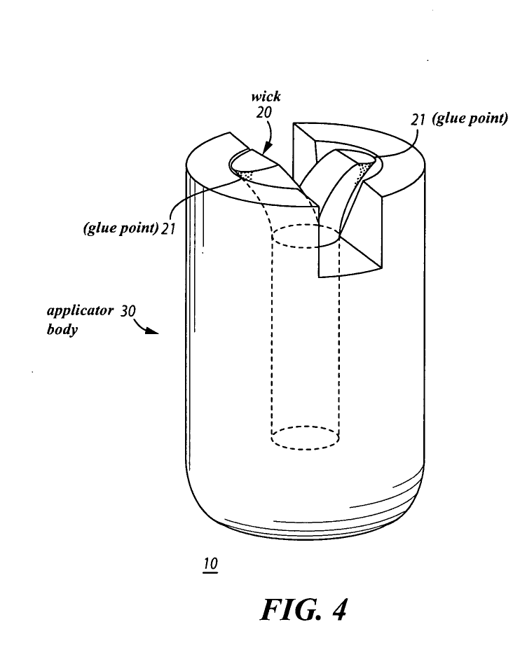

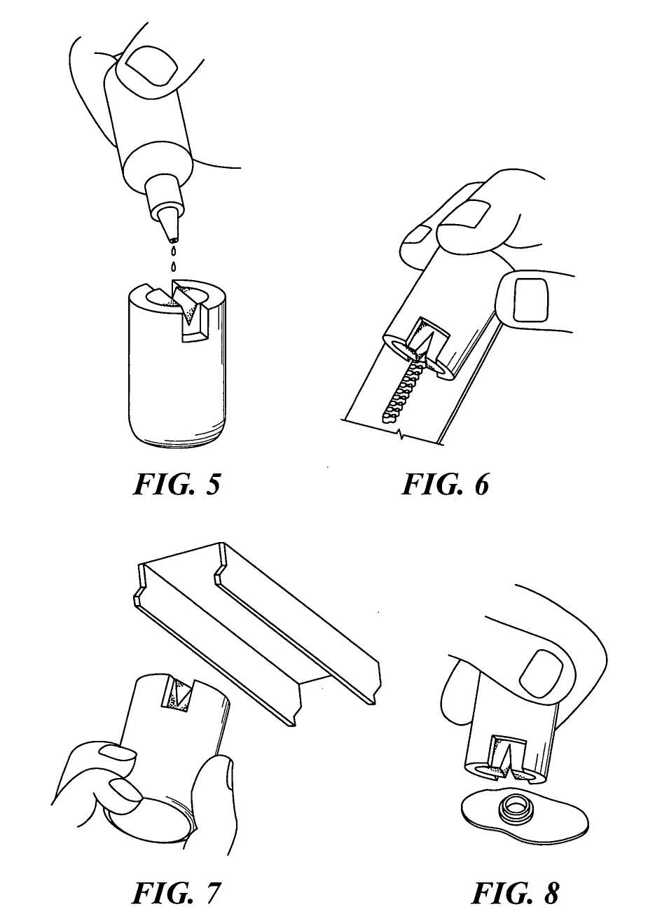

The present invention has a holder and an insert. In one embodiment, insert 20 has an outer surface 27 and at least two sections which meet along interface 26 on one end which may be manually or mechanically separated when needed. FIG. 2 shows insert 20 whereby a channel 23 has been formed by the separation of opposing inner surfaces 24 and 25 which were separated along interface 26 and each have identical upper surfaces 22. The entire apparatus 10 is formed by placing insert 20 into holder 30. Holder 30 has inner cavity 37 whereby expanded flanged surface 35 increases circumferally as it extends past horizontal floor 36 of upper channel 33. Upper channel 33 is formed by opposing vertical members 33 and horizontal floor 36 formed on one end of the apparatus. FIG. 3 shows a cross section of one embodiment of an apparatus of the present invention. In this embodiment holder 30 receives insert 20. Expanded flanged surface 35 is seen with increasing circumference on one end. FIG. 4 shows the assembled apparatus 10 with insert 20 placed inside holder 30. The edges of the insert are separated in order to receive lubricating solution. The cavity formed by the separation of the insert portions provides the apparatus the ability to receive a raised portion of a surface. The raised portion enters the cavity formed by the separated insert portions and allows the surface to contact the insert. FIG. 5 shows lubricant being applied to the insert. FIG. 6 shows the apparatus of the present invention being used to lubricate a zipper. FIG. 7 shows the track of a conventional sliding glass door or window track. FIG. 8 shows the invention lubricating a conventional closure known as a snap fastener.

The insert of the present invention may be made of any suitable porous material. Such materials may include, but would not be limited to polymer foams and cotton. In a preferred embodiment, absorbent felt is used. The separate portions of the present invention may be separated by any acceptable means such that the receiving cavity in the insert is formed. In a preferred embodiment, the separate portions of the insert are separated manually. In one embodiment, there may be a mechanical means for separating the separate portions such that they form the receiving cavity. The holder of the present invention may be made of any acceptable material. These may include, but would not be limited to wood, metal, or plastic. In a preferred embodiment, the holder may be formed of nylon material formed by injection molding. The outer surface of the holder may be smooth or textured. Furthermore, the outer surface may be covered with a suitable textured material such that the user can easily grip the holder.

A method of using the apparatus of the present invention involve the steps of:

1. Placing an absorbent insert into the holder;

2. Separating the portions of the absorbent insert such that a receiving cavity is formed;

3. Lubricating absorbent insert;

4. Placing a track, zipper or snap fastener in the receiving cavity;

5. Moving the apparatus in order to lubricate the raised or protruding surface within said receiving cavity.

6. Operating the lubricated article to ensure increased lubrication and decreased friction.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. An apparatus for lubricating a raised surface comprising:
a. an insert, whereby said insert forms a receiving cavity;
b. a holder for receiving said insert;

2. The apparatus of claim 1 where said raised surface is a sliding glass door track, a window track, a zipper or a snap fastener.

3. The apparatus of claim 1 wherein said insert is made of an absorbent material.

4. The apparatus of claim 1 wherein said insert is made of polymer foams, felt, or cotton.

5. The apparatus of claim 1 wherein said insert is made of felt.

6. The apparatus of claim 1 wherein said insert is separated to form a receiving cavity.

7. The apparatus of claim 1 wherein said insert is separated by manual or mechanical means to form said receiving cavity.
A method of using the apparatus of the present invention involve the steps of:
a. Placing an absorbent insert into the holder;
b. Separating the portions of the absorbent insert such that a receiving cavity is formed;
c. Lubricating absorbent insert;
d. Placing a track, zipper or snap fastener in the receiving cavity;
e. Moving the apparatus in order to lubricate the raised or protruding surface within said receiving cavity; and
f. Operating the lubricated article to ensure increased lubrication and decreased friction.
